(19) United States
(12) Patent Application Publication
(10) Pub. No.: US 2012/0251984 A1
(43) Pub. Date: Oct. 4, 2012

(54) SYSTEM AND METHOD FOR ADVANCEMENT OF VOCABULARY SKILLS IN A GAME ENVIRONMENT

(76) Inventors: Marc TINKLER, New York, NY (US); Georgia Scurletis, Brooklyn, NY (US)

(21) Appl. No.: 13/075,863

(22) Filed: Mar. 30, 2011

(51) Int. Cl. G09B 19/00

(52) U.S. Cl. 434/156

(57) ABSTRACT

A system and method for providing a word game for honing of vocabulary skills includes populating, by a computer processor, a tile grid with a plurality of words related by a predefined criterion, such that each of the words is adjacent to at least one other of the words to form a path beginning at a start grid tile and ending at an end grid tile, the start and end tiles being at least one edge of the tile grid; and transmitting and/or outputting the populated tile grid. The predefined criterion may be, for example, that all of the words are synonymous with respect to at least one word sense of a seed word.

### FIELD OF THE INVENTION

The present invention relates to a system and method that facilitates the learning of vocabulary via generation of a game based on a meaning of a word. The present invention further relates to a system and method for generating a word maze including a string of related words as a path extending between edges of the maze.

### BACKGROUND

Traditional vocabulary learning methods often require tedious memorization of words and their definitions without or with little elements exciting interest. Students grow quickly tired of learning exercises for learning of vocabulary. A learning system and method for learning vocabulary in a fun manner that makes such learning enjoyable would be advantageous.

### SUMMARY

A computer-implemented method for providing a word game for honing of vocabulary skills, according to an example embodiment of the present invention, may include: populating, by a computer processor, a tile grid with a plurality of words related by a predefined criterion, such that each of the words is adjacent to at least one other of the words to form a path beginning at a start grid tile and ending at an end grid tile, the start and end tiles being edges of the tile grid; and transmitting and/or outputting, by the processor, the populated tile grid.

In an example embodiment, the plurality of words are related as synonyms of each other.

In an example embodiment, the start tile is at a first one of the edges and the end tile is at a second one of the edges that is opposite the first edge.

In an example embodiment, the method further includes: subsequent to the populating of the tile grid with the plurality of related words, inserting distracting words into all remaining unpopulated tiles of the grid, such that the distracting words populating the remaining tiles of the grid do not form a path that is of words related by the predefined criterion and that extends between opposite edges of the grid.

In an example embodiment, each of the distracting words is selected according to a condition that the word is not related to the plurality of related words by the predefined criterion.

In an example embodiment, the distracting words are inserted into the grid according to a programmed condition that no word other than the plurality of words forming the path is immediately adjacent to any of the plurality of related words in any of four primary directions of the any of the plurality of words.

In an example embodiment, the method further includes selecting the plurality of related word, where the selection includes: obtaining a seed word; searching for word senses of the seed word; sorting the word senses obtained by the searching in order of frequency of use; selecting one of the word senses based in the sorting; and obtaining words related by the predefined criterion to the seed word according to the selected word sense.

In an example embodiment, the populating of the tile grid with the plurality of related words includes: generating a plurality of versions of the tile grid, each with a different path of the plurality of related words; and selecting one of the versions for output. In an example embodiment, the version selection is random. In an example embodiment, prior to the selecting of the one of the versions, the versions are sorted by a respective number of turns in the respective paths of each respective one of the versions, and a subset of the versions are deleted based on the sort by the respective number of turns, the selection of the one of the versions being from those versions remaining after the deletion of the subset.

In an example embodiment, the populating of the tile grid with the plurality of related words includes, after placement of a first of the plurality of related words in the tile grid, iteratively inserting a non-inserted one of the plurality of related words immediately adjacent to a previously inserted one of the plurality of related words according to programmed conditions that a tile into which it is inserted: (a) is immediately adjacent to, and in one of four primary directions of, the last filled grid tile; (b) is not immediately adjacent in any of four primary directions to more than one grid tile previously filled with a respective word of the plurality of related words previously filled grid tiles; and (c) has not yet been filled with a word.

In an example embodiment, in each of the iterations, the non-inserted word is inserted into a tile according to a further programmed condition that the grid tile into which it is inserted is not on a same edge of the grid as the tile populated with the first of the plurality of related words.

In an example embodiment, each of the distracting words is selected according to a condition that the word is of a same part of speech as the plurality of related words.

In an example embodiment, the populated tile grid is output in a user-interactive interface, via which tiles of the grid are selectable by the user for marking tiles as belonging to the path. The markings may be automatically recorded and compared to the path, and the interactive interface may be such that an indication of correctness of the user selections is output by a processor.

A computer system for providing a word game for honing of vocabulary skills, according to an example embodiment of the present invention, may include a computer processor configured to: populate a tile grid with a plurality of words related by a predefined criterion, such that each of the words is adjacent to at least one other of the words to form a path beginning at a start grid tile and ending at an end grid tile, the start and end tiles being at edges of the tile grid; and transmit and/or output the populated tile grid.

In an example embodiment, the plurality of words inserted by the system are related as synonyms of each other.

In an example embodiment, the start tile is at a first one of the edges and the end tile is at a second one of the edges that is opposite the first edge.

In an example embodiment, the processor is configured to, subsequent to the population of the tile grid with the plurality of related words, insert distracting words into all remaining unpopulated tiles of the grid, such that the distracting words populating the remaining tiles of the grid do not form a path of words related by the predefined criterion that extends between opposite edges of the grid.

In an example embodiment, the population, by the system, of the tile grid with the plurality of related words includes, after placement of a first of the plurality of related words in the tile grid, iteratively inserting a non-inserted one of the plurality of related words immediately adjacent to a previously inserted one of the plurality of related words according to programmed conditions that a tile into which it is inserted: (a) is immediately adjacent to, and in one of four primary directions of, the last filled grid tile; (b) is not immediately adjacent in any of four primary directions to more than one grid tile previously filled with a respective word of the plurality of related words previously filled grid tiles; and (c) has not yet been filled with a word.

A non-transitive computer-readable medium, according to an example embodiment of the present invention, has stored thereon processor-executable instructions, the instructions which, when executed, cause the processor to perform a method for providing a word game for honing of vocabulary skills, where the method includes: populating a tile grid with a plurality of words related by a predefined criterion, such that each of the words is adjacent to at least one other of the words to form a path beginning at a start grid tile and ending at an end grid tile, the start and end tiles being at edges of the tile grid; and transmitting and/or outputting the populated tile grid.

The various methods described herein may be practiced, each alone, or in various combinations.

An example embodiment of the present invention is directed to a processor, which may be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to a hardware computer-readable medium, e.g., as described above, having stored thereon instructions executable by a processor to perform the methods described herein.

An example embodiment of the present invention is directed to a method, e.g., of a hardware component or machine, of transmitting instructions executable by a processor to perform the methods described herein.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates an example word maze, according to an example embodiment of the present invention.

FIG. 2 is a flowchart that illustrates a method for providing a word maze, according to an example embodiment of the present invention.

FIG. 3 is a flowchart that illustrates a synonym selection method according to an example embodiment of the present invention.

FIG. 4 is a flowchart that illustrates a method for generating a word path according to an example embodiment of the present invention.

FIG. 5 is a block diagram illustrating a system according to an example embodiment of the present invention.

### DETAILED DESCRIPTION

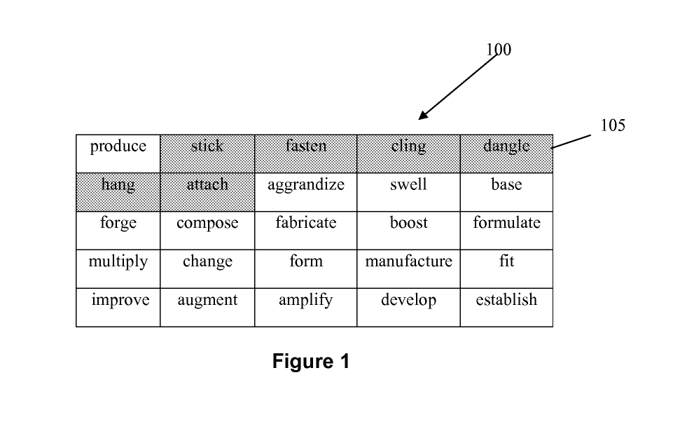

FIG. 1 shows an example maze 100 of words that may be constructed by a system and method according to an example embodiments of the present invention. The maze 100 may include a grid of spaces, each populated with a word. The words populating the maze 100 may include a set of words that are synonyms of a seed word, which set of words are positioned in the maze 100 to form a synonym path 105 extending from a first edge of the maze 100 to a second edge of the maze 100. In FIG. 1, the path 105 is shaded for illustrative purposes. However, in an example embodiment, the maze may be output in a user-interactive interface such that as the user selects words of a grid which includes the maze, the selected words may be automatically highlighted, to visually identify the history of word selections during maze play. The words shown in the maze 100 of FIG. 1 are an example set of words. The system and method of the present invention may construct different mazes with different sets of synonyms.

In an example embodiment of the present invention, a seed word used for construction of the maze 100 may be included in the maze 100. In an alternative example embodiment, the seed word may be omitted from the maze 100. For example, referring to FIG. 1, the words of path 105 may be synonyms of a seed word “adhere,” which is omitted from the maze 100.

While the maze 100 shown in FIG. 1 has an equal number of spaces along orthogonal edges, in other example embodiments, an N×M grid may be used instead of an N×N grid. Further, while the maze 100 is shown to include 5 spaces along each edge, mazes of other sizes may be constructed as described in further detail below.

In an example embodiments of the present invention, the path 105 of synonyms may extend between edges that are orthogonal to each other. In an alternative and preferred example embodiment of the present invention, the system and method of the present invention may construct the maze 100 such that an edge at which the path 105 begins and an edge at which the path 105 terminates are opposite and parallel each other, for example as shown in FIG. 1.

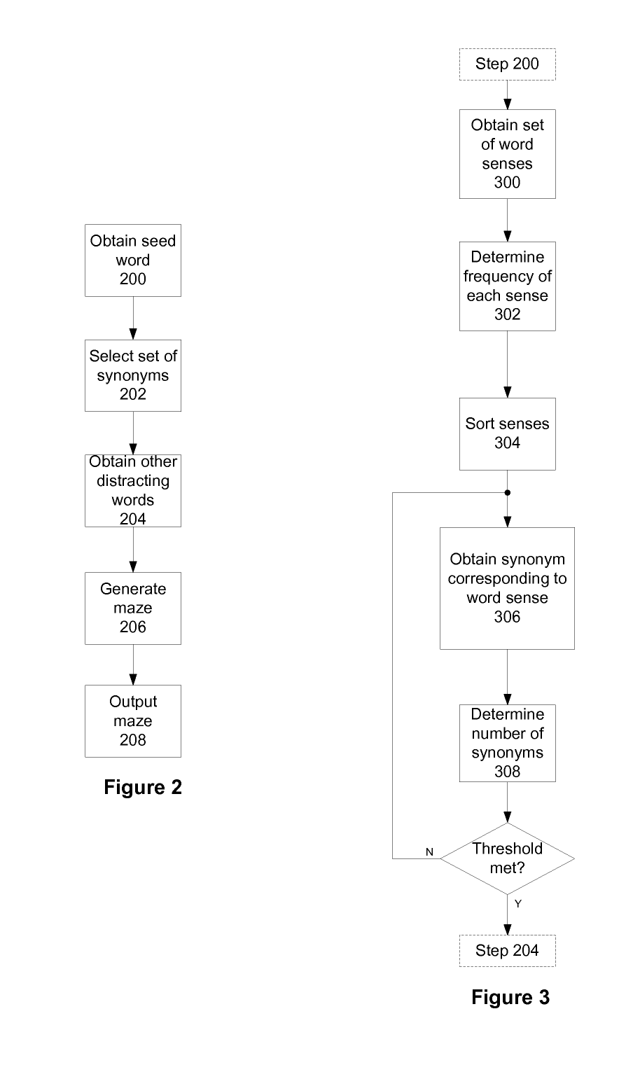

Referring to FIG. 2, in an example embodiment of the present invention, the system may, at step 200, obtain a seed word. For example, the system and method may output a graphical user interface (GUI) via which a user may enter the seed word. Alternatively, the system and method may receive a user-input instruction to provide a word maze, which instruction does not specify a seed word, and the system and method may arbitrarily select a seed word. In an example, such selection may be restricted by the user, e.g., by indication of desired degree of difficulty and/or corpus from which the word is to be selected. For example, it may be desired to enhance learning of vocabulary with respect to words included in certain texts used by students. For example, if a class is studying a particular chapter of a certain book, a teacher may desire for the system to output a word maze using a word found in that chapter of that book.

According to an example embodiment of the present invention, where the system selects the seed word, the system may include the seed word in the maze. According to an example embodiment, where the user selects the seed word, the system may omit the seed word from the maze. Alternatively, the seed word may be included regardless of whether the user or system selects the seed word. Alternatively, the seed word may be omitted regardless of whether the user or the system selects the seed word.

At step 202, the system and method may select a set of synonyms of the seed word.

At step 204, the system and method may obtain a set of other words, e.g., that are not synonyms of the seed word for inclusion in the maze in spots or grid tiles not part of the synonym path. In an example embodiment, the system and method may be configured such that such other words included in the maze do not include a synonym of the seed word. In an alternative example embodiment, the other words may also include synonyms of the seed word, for example, so long as only one complete synonym path of synonyms of the seed word is included in the maze or so long as any such word is not placed adjacent to any other synonym of the seed word. The other words may include additional sets of synonymous words, which may be positioned adjacent to each other in the grid to form additional paths, so long as any such path does not form a complete synonym path extending from a first edge of the grid to an opposite parallel edge of the grid. In an alternative example embodiment, where the seed word is known to the user, such as where the user inputs the seed word on the basis of which input the system and method generates the synonym maze, or where the system outs an identification of the seed word, the system may include in the grid complete synonym paths for distracting words as well.

One, more, and/or all of such other distracting words may be user-selected. For example, a teacher may input into the system distracting words for inclusion in the maze in spaces not forming part of the synonym path, which the system may subsequently uses to generate the maze. Alternatively, the system may automatically select the other words. In an example embodiment, the user may have the option of entering words for inclusion in the grid. To the extent the user enters fewer distracting words than required for completing the grid, the system may automatically select the remaining words.

In an example embodiment of the present invention, where the system selects distracting words for inclusion in the maze, the system may initially select a small group of words and then, for one or more of those initially selected distracting words, select synonyms of those words. The selection of the synonyms may be according to the constraints described above, for example, as to words that are also considered synonyms of the seed word or its synonyms and/or as to formation of other complete synonym paths.

At step 206, the system and method may generate a maze including the set of synonyms and/or the seed word. At step 208, the system and method may output the maze.

The output of the maze may be for example via a GUI in an electronic display device and/or via a printer. According to an example embodiment of the present invention, the system and method may provide for electronically tracking user interaction with the maze output via the GUI. For example, a user may move a pointer, for example, using a mouse to one of the spaces and select the space, e.g., with a mouse click or a key entry, or may otherwise select a space, e.g., using the user's hand via touch-screen. The system and method may record each such selection. In an example embodiment, the system and method may visually indicate which spaces the user has selected, for example, by shading the selected spaces. The system and method may allow the user to deselect a space the user previously selected, e.g., where each click of a space toggles between selection and deselection. In an example embodiment of the present invention, the system and method may only allow selection of a space only if it is either at an edge of the maze or is otherwise immediately adjacent to another space that has already been selected.

In an example embodiment of the present invention, where the selected spaces include all of the set of synonyms used by the system to create the synonym path of the maze and does not include any other word, the system may output an indication that the maze has been correctly solved. In an example embodiment of the present invention, where the selected spaces complete a path extending between two edges of the grid, e.g., between two opposite edges of the grid, and the selected spaces fail to include all of the set of synonyms used by the system to create the synonym path and/or includes one or more words that do not belong to the set of synonyms, the system and method may, in response to a selection that completes such a path, output an error message.

In an example embodiment of the present invention, if, during space selection by the user, the user attempts selection of a space that violates a rule of the maze, the system and method may output error message indicating that the space may not be selected. Alternatively or additionally, after selection of each space, e.g., but for a space at an opposite edge of a start word completing a synonym path, the system and method may indicate which surrounding spaces may be selected without violating a maze rule. For example, in an example embodiment, a maze rule may be that a path may extend from one space to a second space in only one of four primary directions (up, down, right, left) and not diagonally. Additionally, a maze rule may be that each newly selected space for the maze path must not abut more than one previously selected space of the path. Accordingly, after selection of at least one of the spaces by the user for inclusion in a solved synonym path, the system and method may automatically indicate which spaces surrounding the last selected space do not violate such maze rules if selected. Such indications may be, for example, via highlighting or using other visual indications.

FIG. 3 is a flowchart that illustrates steps, according to an example embodiment of the present invention, that the system and method of the present invention may perform for selection of synonyms in step 202. At step 300, the system and method may obtain a set of word senses of the seed word. In this regard, a word may be used in a number of ways, corresponding to the various senses. For example, one sense of the word “hang” is to suspend something on, another sense of the word is to remain at attention, and still another sense of the word is an understanding (to get the hang of something), etc. The system and method may obtain the set of senses from a database of words and corresponding senses.

At step 302, the system and method determine the frequency at which the seed word is used with each sense. For example, each of a plurality of instances or a plurality of words in a large corpus may be tagged, e.g., manually, with the sense with which the word is used in the corpus in that respective instance. The system may determine the frequency, e.g., number of times per million, of each tagged sense of the seed word in the corpus.

At step 304, the system and method may sort the senses of the seed word to form an ordered list from most frequent to least frequent.

At step 306, the system and method may, beginning with the most frequent sense, obtain the synonyms of the seed word for that word sense. For example, the system and method may access a database identifying synonyms of a word per word sense.

At step 308, the system and method may determine the number of obtained synonyms there are for the word sense. If the number of obtained synonyms does not meet a threshold, the system and method may return to step 306 to obtain synonyms of the seed word for the next most frequent sense.

The selection of the set of synonyms may be final once the number of synonyms meets the threshold. The threshold may be based on maze rules and/or grid size. For example, a maze rule may require at least three words, e.g., including the seed word. This may be so because a two word set would require extending from a first edge to a second edge with just one movement between spaces, hardly allowing a player to make mistakes when trying to solve the maze. Similarly, a maze rule may require at least one turn or at least four spaces of a straight line for a valid maze path, both of which require at least four words. In an alternative example embodiment, the system and method may require at least two turns, requiring at least six words, assuming (a) a rule that each synonym in the synonym path can touch only two other synonyms of the synonym path in a primary direction, and (b) a rule that, during generation of the maze, a first placed word is placed at first edge (e.g., a left edge) and a connecting word must be placed to extend towards an opposite edge (e.g., to the right of the first placed word).

In an example embodiment, one or more of the rules may be applied where applicable and otherwise ignored. For example, steps 306 and 308 may initially be repeatedly performed based on a threshold number of words allowing for two turns. If the system cycles through all synonym sets without finding one that includes that threshold number of words, the system may re-perform iterations of steps 306 and 308 using a lower threshold number that allows just one turn. Similarly, in an example embodiment, if the system cycles through all synonym sets without finding one that includes the threshold number of words allowing for at least one turn, the system may re-perform iterations of steps 306 and 308 using a lower threshold number that does not allow for inclusion of any turn.

Additionally, in an example embodiment of the present invention, the system and method may provide for obtaining user-input specifying a desired grid size. For example, the user may specify that the generated grid including the word maze is to be 8×8. Accordingly, the system would discard any sense for which the system does not obtain at least eight words. In an example embodiment, a maze rule may be that at least one turn is required, in which case nine words would be required, or at least two turns are required, in which case ten words would be required. As noted above, one or more of such rules may be used in first iterations and then discarded if no word sense is associated with a synonym set including the number of words required for satisfying the condition.

If the user selects a seed word and a grid size, and the selection is such that the system cannot obtain a set of synonyms for any sense of the seed word that includes enough words to form a maze path in a grid of the selected size and meeting all required maze rules, the system and method may output an error message indicating the failure. Alternatively, the system and method may, in such an instance, select the greatest grid size for which the system can generate a synonym maze meeting all required maze rules.

In an example embodiment of the present invention, the system and method may automatically select a grid size based on the number of words in a set of synonyms for the seed word, without user input of a desired grid size. For example, the system may be configured to select the size based on the number of words in the set of synonyms for the most frequently used sense of the seed word, so long as maze rules are met. For example, it the maze rules require at least two turns, the system may select a grid size that allows for at least two turns considering the number of synonyms associated with the most frequently used word sense. If a grid meeting all maze rules cannot be formed for the set of synonyms of the most commonly used sense of the seed word, then the system may select the grid size and generate the grid based on the set of synonyms of a less frequently used sense of the seed word, for example, a most frequently used sense of the seed word for which a maze meeting the maze rules can be generated. If the respective sets of synonyms for all of the senses of the seed word each does not include enough words for generation of a maze meeting all maze rule requirements, the system and method may output an error message, the maze not being generated. However, as noted above, certain rules may be waived where a synonym set cannot be obtained which allows for satisfying all maze rule conditions. Accordingly, the system and method may iteratively re-perform the search for the synonym set after discarding a respective rule after each iteration, until a synonym set meeting the remaining rules is obtained.

In an example embodiment, frequency of use of a word sense and certain ones of the maze rules may be weighted for selection of the synonym set. For example, where one synonym set does not include enough words to meet the threshold required for satisfying such a maze rule is associated with a first word sense used much more frequently than a second word sense whose set of synonyms does include enough words to meet the threshold required for satisfying the maze rule, the system may select the synonym set of the more frequently used word sense if the value calculated using the weightings for the more frequently used word sense is higher than the value calculated using the weightings for the less frequently used word sense.

In an alternative (or additional) example embodiment, where the respective sets of synonyms for all of the senses of the seed word each does not include enough words for generation of a maze meeting all maze rule requirements, the system and method may generate a grid using words from a combination of the sets of synonyms of multiple senses of the seed word. Since this may be confusing, the system and method may output a message indicating the maze's basis on the combination. Alternatively, the system and method may output a message indicating that the maze cannot be generated based on a single sense of the word and may be configured for receiving user input indicating whether to create the maze based on the combination of word senses. The system and method may then either generate the maze based on the combination, or not, depending on the user input.

Where a grid size is not selected, then, for a particular seed word, with respect to word senses whose respective sets of synonyms include words that meet the required threshold for generation of a word maze, in an example embodiment, instead of strictly selecting the most frequently used word sense, in an example embodiment of the present invention, the system and method may select the set of synonyms based on a weighting system in which the frequency of use is a factor and the number of synonyms in the synonym set is a factor. For example, frequency of use may be measured in number of times of use per million words. That number may be multiplied by a respective predetermined weight. Additionally, the number of words in the word set may be multiplied by a respective predetermined weight. Those products may be summed, and the word sense/set of words for which the highest total is calculated may be selected.

In an example embodiment of the present invention, even where a grid size is selected, where synonym sets of multiple word senses include the threshold number of words, the system may nevertheless apply the weighting calculation instead of strictly selecting the most frequently used word sense whose respective set of synonyms includes the threshold number of words. This may be advantageous because it may allow the system to generate mazes with different combinations of words from the selected word set over time. For example, where the synonym set includes more than the threshold number of words, the system may apply an algorithm for randomized selection of words from the word set, so that different mazes generated for the seed word include different words of the respective synonym set.

In an example embodiment of the present invention, aside from use frequency and/or number of words in the synonym set, an additional factor which may be weighted for selection of a synonym set may be the last time the synonym set was used, such that the total value calculated for a synonym set is lowered after use of the synonym set, and is raised each time another synonym set is selected for the seed word. This may raise the likelihood of cycling through word senses.

Referring again to FIG. 3, in example embodiments of the present invention, one or more of the steps of FIG. 3 need not be performed in response to each request for a synonym maze. For example, steps 300 to 308 may be performed once, or on a periodic basis, e.g., of equal time intervals, such as daily or monthly, to account for updates to the database of synonyms and/or the tagged words of a text corpus from which use frequency is determined. Based on the single or periodic performance of those steps, a database may be updated which identifies a set of seed words in association with respective pointers to multiple synonym sets in association with a grid size indication. For example, for each of a plurality of grid sizes, the database may point to one of the synonym sets of the seed word for the most frequently used word sense whose synonym set includes at least the threshold number of words for the selected grid size. Where a grid size is not selected, the system and method may use the threshold associated with the smallest allowable grid size according to the maze rules.

Alternatively, the system may store a table of seed words and identifications of respective numbers of words for different word senses, which numbers are sorted in order of word sense frequency, for example, as shown in Table 1. The numbers may be associated with pointers to the corresponding synonym set. The system and method may therefore obtain a synonym set using a pointer associated with the first listed number which meets the required threshold. For example, referring to Table 1, for selection of a synonym set for “Seed word 1” (“Seed word 1”-“Seed word 3” are shown for illustrative purposes and correspond to actual words which may be user or automatically selected), for a grid size requiring at least 5 words, the system and method may use the pointer associated with the first listed number, since (a) its synonym set is indicated to include 15 words, meeting the threshold number, and (b) it is the first listed number, indicating that it corresponds to the most frequently used word sense. On the other hand, for a grid size requiring at least 20 words, the system and method may use the pointer associated with the last listed number, since only it meets the required threshold.

TABLE 1

| | | | | |
|---|---|---|---|---|
| Seed word 1 | 15 | 11 | 8 | 20 |
| Seed word 2 | 5 | 9 | 3 | 7 |
| Seed word 3 | 8 | 5 | 11 | 9 |

Any suitably appropriate relational database structure and access method may be used for storing relationships of seed words, word senses, sorted word sense frequencies, and numbers of words of synonym sets, and access thereof to obtain, for a selected seed word, a synonym set for generation of the synonym maze. According to an example embodiment, the database may be updated periodically, as explained above. According to the example embodiment in which word sense use frequency and number of words of the synonym set are weighted, the relational database may include the computed scores and/or may sort the pointers to the synonym sets by the computed scores. According to the example embodiment in which the scores may be updated in response to use of synonym sets for generation of the synonym mazes, the system and method may update a field indicating an order of last use of the synonym set in response to each use of the synonym set. The computed score may be updated responsive the update of that field, and therefore, each time a maze is generated, either in response to a request for the maze and prior to selection of the synonym set for the generation of the maze or subsequent to the generation of the synonym set. Alternatively, the score may be updated on the periodic basis upon which other information of the database is updated, as discussed above.

In an example embodiment of the present invention, instead of the system automatically selecting between word senses, the system may provide the user the option to select a word sense on which basis to generate the synonym maze.

Referring again to step 204 of FIG. 2, where the system and method automatically selects distracting words for inclusion in the word maze, the system and method may, for example, select such words on a random basis from a pool of words sharing the same part of speech as the selected word sense of the seed word. This may be advantageous because, if words having different parts of speech are included, it may be easier for the player to recognize which words are the distracting words.

However, in an example embodiment of the present invention, the system and method may output a word maze without receipt from the user of a seed word and without output to the user of an identification of the seed word. In such a scenario, in an example embodiment of the present invention, the system and method may also use distracting words having a part of speech different than that of the word sense of the seed word for which the synonym maze is generated.

The words included in the set of synonyms of a word sense of a seed word may include words tagged as strict synonyms of the seed word and also words tagged with other tags in the synonym family which are not strict synonyms, e.g., that cannot be used as a substitute for the seed word. For example, for a word sense as an adjective, the set of words used for generation of the synonym maze may include words tagged as “See Also” and/or “Similar To” words of the word sense of the seed word. For a word sense as a verb, the set of words used for generation of the synonym maze may include words tagged as “Verb Group” words of the word sense of the seed word. The system and method may, for example, mine known data stores of such tagged words, e.g., a data store maintained by WORDNET®. An operator may manually filter the synonym sets to remove inappropriate words. For example, the system may initially include all “Similar To” words for a word sense of a seed word, and an operator may determine that one, some, or all of such words are too different to be considered in the category of synonyms, and may accordingly manually modify the set of synonyms by removal of such inappropriate words.

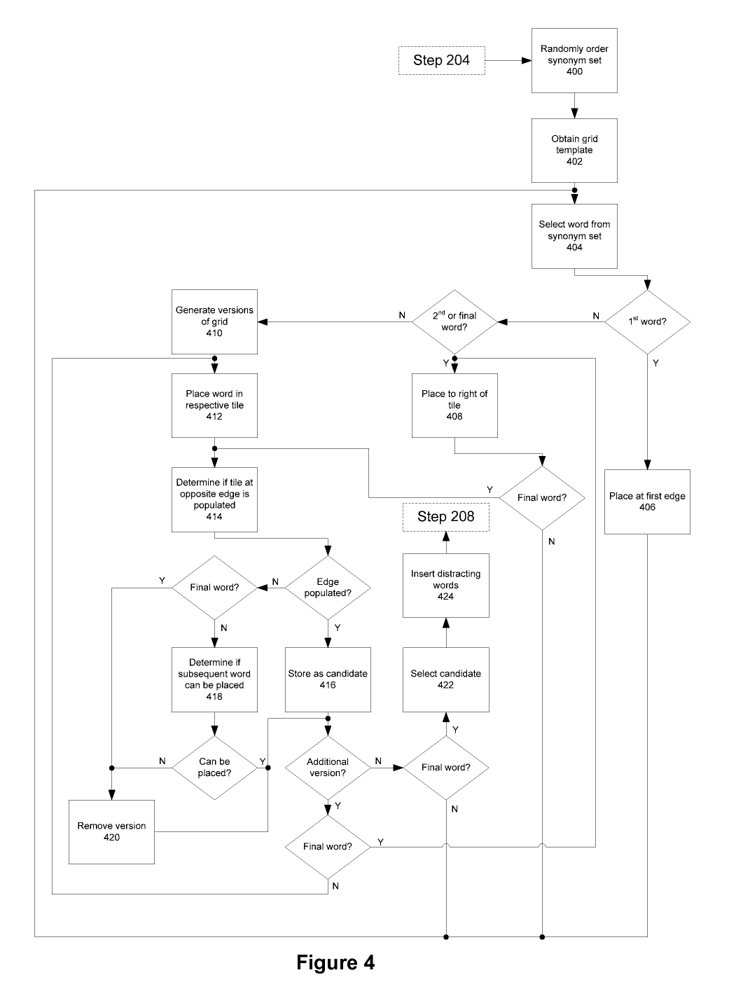

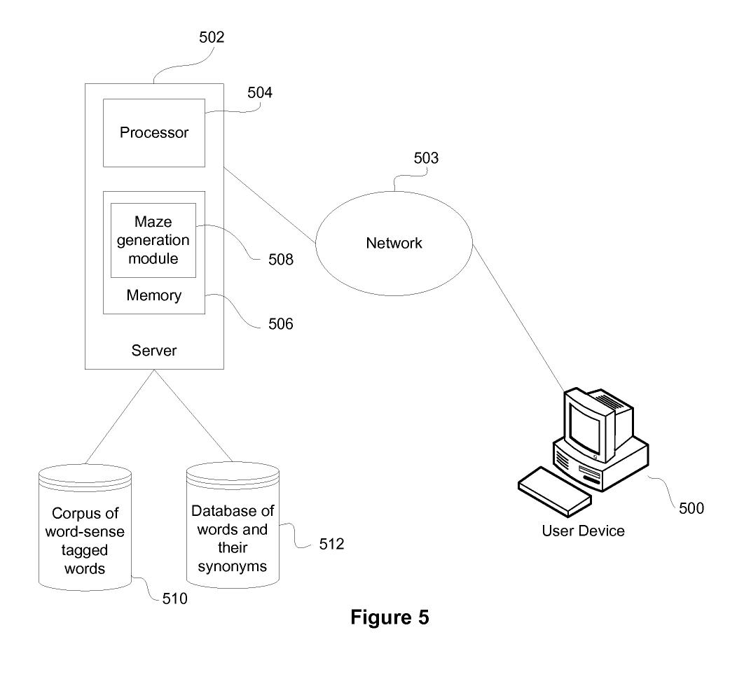

FIG. 4 is a flowchart that illustrates steps, according to an example embodiment of the present invention, that the system and method of the present invention may perform for generating the synonym maze in step 206. The sequence of the steps shown in FIG. 4 are illustrative and do not imply a required sequence. Additionally, one or more of the steps may be omitted.

At step 400, the system and method may randomly order the synonym set (which might or might not include the seed word depending on embodiment and/or whether there are a sufficient number of words to generate a synonym maze complying with the maze rules with which the system is programmed or to generate an optimal synonym maze, e.g., including at least one or at least two turns).

At step 402, a grid template is obtained from memory. The grid template may be of a size selected by a user or one that is automatically selected, as described above.

At step 404, the system and method selects a word from the synonym set, beginning with the first of the randomly sorted words.

At step 406, the selected word is placed in one of the spaces of the grid. For this step, the first of the selected words is placed in a tile at the left edge of the of the grid template. (The left edge is merely an example of one of the possible edges at which the system may be configured to begin population of the grid. Regardless of the edge at which the system is configured to begin, the system may be configured to place other words from the synonym set in the grid such that the final word that ends the synonym path ends at an edge that is opposite the beginning edge.)

After placement of the first of the words of the synonym set, the system and method may return to step 404 to select a second one of the words of the synonym set. At step 408, the system and method may place the second word to the tile that is to the right of (assuming the beginning edge is the left edge), and adjacent to, the tile in which the first word was placed.

After placement of the second of the words of the synonym set, the system and method may return to step 404 to select a word following the last selected word of the synonym set.

At step 410, for each subsequently selected word, for example besides for the last of the words, the system and method may generate multiple copies of the grid including the incomplete word maze, for placement of the latest selected word in a respective one of all grid tiles that satisfy all of the following conditions: it (a) is immediately adjacent to the last filled grid tile; (b) is at a primary direction of the last filled grid tile (above, below, right, or left); (c) is not immediately adjacent to more than one previously filled grid tiles in a primary direction of the previously filled grid tile; (d) is not on a same edge as the tile populated with the first selected word; and (e) has not yet been filled with a word.

For example, the system and method may generate three versions of the grid for the third selected word, assuming the third selected word is not the last word. In a first of the versions, the word may be placed in a tile that is to the immediate right of the last filled tile. In a second of the versions, the word may be placed in a tile immediately above the last filled tile. In a third of the versions, the word may be placed in a tile immediately below the last filled tile. (A version for placement of the word in a tile to the left of the last filled tile is not generated because that left tile already includes the first placed word.)

At step 412, the system and method may place the selected word in the respective tile of each of the generated copies of the grid according to previously described conditions (a)-(e).

At step 414, for each of the versions of the grid having a word populated during the last performance of step 412, the system and method may determine whether a tile at an edge of the grid that is opposite the edge where the first populated tile is located has been populated. If such a tile has been populated, the system and method may, at step 416, store the version as a candidate for output.

At step 418, for each of the remaining versions of the grid having a word populated during the last performance of step 412 and which does not have a populated tile at an edge opposite the starting edge, the system and method may determine whether a subsequently selected word can be placed in the grid. For example, an incomplete word maze formed by the latest performance of step 412 may be structured such that placement of a subsequently selected word would require violation of a maze rule.

For each of the versions for which a subsequently selected word cannot be placed in the grid, the system and method may, at step 420, delete the respective version of the grid.

For all remaining versions that have not been deleted and that do not include a populated tile at an edge opposite the starting edge, the system and method may then loop back to step 404. The number of versions generated for each performance of step 410 may therefore increase in an exponential-like manner for each subsequent iteration. For example, three versions of the grid may be generated during the first performance of step 410, seven versions of the grid may be generated during the second performance of step 410, and fourteen versions of the grid may be generated during the third performance of step 410.

For each remaining version of the grid, if the word selected at step 404 is the final word of the synonym set, the system and method may, at step 408, place the final word in the tile that is to the right of (assuming the beginning edge is the left edge), and adjacent to, the tile in which the prior placed word was placed. For each remaining version of the grid, the system and method may also, at step 414, determine whether a tile at an edge of the grid that is opposite the edge where the first populated tile is located has been populated. If such a tile has been populated, the system and method may, at step 416, store the version as a candidate for output. If such a tile has not been populated, the version may be determined to be invalid because a maze path has not been completed and there are no additional words in the synonym set to add to the maze path. The system and method may therefore, at step 420, delete the respective version of the grid.

Due to possible memory, processing, and/or processing-time constraints, in an example embodiment of the present invention, the system and method may be configured to, during the generation of the maze path, delete grid versions so that no more than programmed threshold number of grid versions are maintained. For example, after each iteration of the loop, e.g., prior to a repeat performance of step 404, the system and method may determine whether the number of active grid versions exceeds the threshold. If the threshold has been exceeded, the system and method may randomly delete one or more of the versions to reduce the number of versions to fewer than the threshold. The selection of versions to be discarded may be random. The random selection may be based on any suitably appropriate randomizing algorithm, for example based on clock cycle.

In an example embodiment, the threshold may be applied to versions having incomplete maze paths. For example, even where the threshold is exceeded, the system and method may be configured such that versions stored as candidates in step 416, which include complete maze paths, are not removed responsive to exceedance of the threshold.

Alternatively, the versions stored as candidates in step 416 may also be deleted responsive to exceedance of the threshold, where the final word has not yet been selected from the synonym set. (Where the final word has already been selected, candidates may be removed in a final step of selecting a single candidate for output.)

In an example embodiment of the present invention, the system and method may be configured to, responsive to exceedance of the threshold, initially sort the versions by number of included path turns, and remove versions from those that have the fewest number of turns. If after all versions having the fewest number of turns have been removed, the threshold is still exceeded, the system and method may remove versions from those of the remaining versions having the next fewest number of turns, etc. In an example embodiment of the present invention, all versions having two or more turns may be treated equally. For each group of versions having the same number of turns, the versions selected for removal may be on a random basis.

In an example embodiment of the present invention, while versions including paths with more turns than paths of other versions may be removed after those versions including the fewer number of turns, where the number of words in the synonym set and the size of the grid are such that complete paths including the greater number of turns cannot be completed, those versions including the greater number of turns may all be removed. Such removal may be part of the removal in response to the exceedance of the threshold or may be performed regardless of the threshold. In an example embodiment, the condition of not including too many turns in view of the number of words included in the synonym set and the grid size may be used as an additional condition during steps 410-412. For example, a word would not be placed in a tile where such placement requires the maze path to include more than the maximum possible number of turns given the number of words in the synonym set and the grid size.

For example, if the synonym set includes 10 words and an 8×8 grid is used, the maximum number of turns for the maze path is two, where a turn is defined as a transition between words that is not in a direction as that extending from the starting edge to the opposite edge. For example, the maze 100 of FIG. 1 includes a maze path 105 having one turn from the word “attach” to the word “stick.” The transition from “stick” to “fasten” is not considered a turn because the transition is from left to right and the left edge is the beginning edge.

After all words have been selected and all versions considered according to the steps described above with respect to FIG. 4, the system and method may, at step 422, select one of the candidate versions for output.

For selection of the candidate for output, the system and method may provide for removal of the simplest of the candidate paths, while ensuring that a variety of puzzles are generated over time for the same input seed word. For example, where candidates include maze paths having no turns and maze paths having one turn, the system and method may remove from consideration the paths having no turns. Where candidates include maze paths having only one turn and maze paths having two turns, the system and method may remove from consideration the paths having just one turn. In an example embodiment, the system and method may equally treat all paths having two or more turns. This may allow for puzzles with varying degrees of difficulty to be output. Additionally, if the system would always select the candidate having the greatest number of turns, a user may eventually realize that a large number of turns is probably required to solve the puzzle, which realization may help the user solve the puzzle. The system and method then randomly selects one of the remaining paths.

In an example embodiment of the present invention, removal of paths based on number of turns may be dependent on the number of candidates. For example, if the number of candidates is below a threshold number with which the system is programmed, the randomized selection may be from the entire corpus of candidates, none being removed based on too few number of turns, in order to allow for a variety of puzzles to be generated over time.

At step 424, the system and method may insert the distracting words obtained in step 204 of FIG. 2 into the remaining unpopulated tiles of the grid. The insertion of the distracting words may be such that the distracting words do not form a complete path of synonyms extending between opposite edges of the grid. In an example embodiment, the insertion of the distracting words may be such that the distracting words do not form a complete path of synonyms extending between any two edges of the grid. In an example embodiment, the insertion of the distracting words may be such that the distracting words do not form a complete path of synonyms extending between any two tiles that are at an edge of the grid.

The formation of incomplete paths of synonyms for the distracting words may follow the same rules and/or steps described above for the generation of the maze pat for the seed words, with the exception that, for example, those paths do not form complete maze paths, or the other exceptions noted above. For example, in an example embodiment, a step such as step 418/420 would not be performed with respect to the distracting words because incomplete word paths of distracting words are not a problem. Similarly, whether or not there are enough synonyms of a distracting word to form a complete synonym path extending between edges of the grid need not be considered when selecting distracting words for inclusion in the grid.

If, after inserting distracting words into the grid such that they form incomplete synonym paths formed in accordance with rules described above as to formation of the synonym path for the seed word, there still remains unfilled grid tiles, the system and method may randomly select any remaining words from the corpus of distracting words.

The system and method may then output the maze at step 208 of FIG. 2.

In an example embodiment of the present invention, the system and method may randomly transpose, e.g., by rotation and/or reflection, the grid generated according to the steps of FIG. 4 prior to its output. Such transposition may add to the variety of puzzles which may be generated.

FIG. 5 is a block diagram showing an example system according to an example embodiment of the present invention. A user device 500 may be operated by a user to transmit a request for a synonym maze to a server 502, for example, over a network 503, such as the Internet. The user may additionally provide to the server, via the user device 500 and/or the network 503, additional information, such as a desired seed word, a grid size, and/or distraction words. The user device 500 may include any suitable input device, for example, a keyboard, touch-screen, stylus, and/or mouse, using which the user may provide the input. The server 502 may include a processor 504 and a memory device 506 storing a maze generation module 508, executable by the processor 504 to perform methods described above to generate and provide to the user device 500 the requested synonym maze. The user device 500 may include an output device, for example, a computer monitor/screen and/or printer, via which to display the generated maze. The server 502 may additionally have access to a corpus 510 of word-sense tagged words indicating the word sense of words in a context, as described above. Such access may be to a local memory or through a network. The server 502 may additionally have access to a database 512 of words and their synonyms, as described above. For example, the database may include table structures such Table 1 above. Such access to the database 512 may be to a local memory or through a network.

Other divisions of the processing between the server 502 and user device 500 may be implemented instead. For example, the user device 500 may include the maze generation module 508 for local generation of the requested maze.

While the above discussion refers to generation of a synonym word maze, the methods and system described above may be similarly used for generating other word mazes, using other groups of related words. For example, mazes may be generated for groups of verbs, groups of adjectives, groups of antonyms where each adjacent pair of words are antonyms of each other, etc.

The above description is intended to be illustrative, and not restrictive. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A computer-implemented method for providing a word game for honing of vocabulary skills, the method comprising:
populating, by a computer processor, a tile grid with a plurality of words related by a predefined criterion, such that each of the words is adjacent to at least one other of the words to form a path beginning at a start grid tile and ending at an end grid tile, the start and end tiles being at least one edge of the tile grid; and
at least one of transmitting and outputting, by the processor, the populated tile grid.

2. The method of claim 1, wherein the plurality of words are related as synonyms of each other.

3. The method of claim 1, wherein the start tile is at a first one of the at least one edge and the end tile is at a second one of the at least one edge that is opposite the first edge.

4. The method of claim 1, further comprising:
subsequent to the populating of the tile grid with the plurality of related words, inserting distracting words into all remaining unpopulated tiles of the grid, such that the distracting words populating the remaining tiles of the grid do not form a path of words related by the predefined criterion that extends between opposite edges of the grid.

5. The method of claim 4, wherein each of the distracting words is selected according to a condition that the word is not related to the plurality of related words by the predefined criterion.

6. The method of claim 4, wherein the distracting words are inserted into the grid according to a programmed condition that no word other than the plurality of words forming the path is immediately adjacent to any of the plurality of related words in any of four primary directions of the any of the plurality of words.

7. The method of claim 4, further comprising:
selecting the plurality of related word, wherein the selecting includes:
obtaining a seed word;
searching for word senses of the seed word;
sorting the word senses obtained by the searching in order of frequency of use;
selecting one of the word senses based in the sorting; and
obtaining words related by the predefined criterion to the seed word according to the selected word sense.

8. The method of claim 4, wherein the populating of the tile grid with the plurality of related words includes:
generating a plurality of versions of the tile grid, each with a different path of the plurality of related words; and
selecting one of the versions for output.

9. The method of claim 8, wherein the selected version is randomly selected.

10. The method of claim 9, wherein, prior to the selecting of the one of the versions, the versions are sorted by a respective number of turns in the respective paths of each respective one of the versions, and a subset of the versions are deleted based on the sort by the respective number of turns, the selection of the one of the versions being from those versions remaining after the deletion of the subset.

11. The method of claim 4, wherein the populating of the tile grid with the plurality of related words includes:
after placement of a first of the plurality of related words in the tile grid, iteratively inserting a non-inserted one of the plurality of related words immediately adjacent to a previously inserted one of the plurality of related words according to programmed conditions that a tile into which it is inserted: (a) is immediately adjacent to, and in one of four primary directions of, the last filled grid tile; (b) is not immediately adjacent in any of four primary directions to more than one grid tile previously filled with a respective word of the plurality of related words previously filled grid tiles; and (c) has not yet been filled with a word.

12. The method of claim 11, wherein, in each of the iterations, the non-inserted word is inserted into a tile according to a further programmed condition that the grid tile into which it is inserted is not on a same edge of the grid as the tile populated with the first of the plurality of related words.

13. The method of claim 4, wherein each of the distracting words is selected according to a condition that the word is of a same part of speech as the plurality of related words.

14. The method of claim 1, wherein the populated tile grid is output in a user-interactive interface, via which tiles of the grid are selectable by the user for marking tiles as belonging to the path, the markings being automatically recorded and compared to the path, and an indication of correctness of the user selections being processor-output.

15. A computer system for providing a word game for honing of vocabulary skills, the system comprising:
a computer processor configured to:
populate a tile grid with a plurality of words related by a predefined criterion, such that each of the words is adjacent to at least one other of the words to form a path beginning at a start grid tile and ending at an end grid tile, the start and end tiles being at least one edge of the tile grid; and
at least one of transmit and output the populated tile grid.

16. The system of claim 15, wherein the plurality of words are related as synonyms of each other.

17. The system of claim 15, wherein the start tile is at a first one of the at least one edge and the end tile is at a second one of the at least one edge that is opposite the first edge.

18. The system of claim 15, wherein the processor is configured to, subsequent to the population of the tile grid with the plurality of related words, insert distracting words into all remaining unpopulated tiles of the grid, such that the distracting words populating the remaining tiles of the grid do not form a path of words related by the predefined criterion that extends between opposite edges of the grid.

19. The system of claim 18, wherein the population of the tile grid with the plurality of related words includes:
after placement of a first of the plurality of related words in the tile grid, iteratively inserting a non-inserted one of the plurality of related words immediately adjacent to a previously inserted one of the plurality of related words according to programmed conditions that a tile into which it is inserted: (a) is immediately adjacent to, and in one of four primary directions of, the last filled grid tile; (b) is not immediately adjacent in any of four primary directions to more than one grid tile previously filled with a respective word of the plurality of related words previously filled grid tiles; and (c) has not yet been filled with a word.

20. A non-transitive computer-readable medium having stored thereon processor-executable instructions, the instructions which, when executed, cause the processor to perform a method for providing a word game for honing of vocabulary skills, the method comprising:
populating a tile grid with a plurality of words related by a predefined criterion, such that each of the words is adjacent to at least one other of the words to form a path beginning at a start grid tile and ending at an end grid tile, the start and end tiles being at least one edge of the tile grid; and
at least one of transmitting and outputting the populated tile grid.
